(19) United States
(12) Patent Application Publication
(10) Pub. No.: US 2022/0274702 A1
(43) Pub. Date: Sep. 1, 2022

(54) AUTONOMOUS AERIAL SYSTEM AND METHOD

(71) Applicant: FLYVIZ INDOOR LTD., Haifa (IL)

(72) Inventors: Gidon MOSHKOVITZ, Haifa (IL); Assaf EZOV, Haifa (IL)

(21) Appl. No.: 17/632,767

(22) PCT Filed: Jul. 27, 2020
(86) PCT No.: PCT/IL2020/050830

§ 371 Date: Feb. 3, 2022

(30) Foreign Application Priority Data
Aug. 4, 2019 (IL) 268486

(51) Int. Cl. B64C 39/02; G01C 21/20

(52) U.S. Cl. CPC B64C 39/024; B64C 39/028; G01C 21/206; B64C 2201/123; B64C 2201/141; G05D 1/104

(57) ABSTRACT

An indoor autonomous aerial system and method that uses micro aerial vehicle/s (MAV/s). Said system is configured to be deployable and operable in reduced GPS signal reception expansive spaces and the MAV/s is/are configured to be automatically guided and perform tasks at desired location/s, transmit/receive data, present various signs, etc. Said system and method can be used for various purposes such as, advertisement, inventory management, guidance, warning, search and rescue, etc.

### FIELD OF THE INVENTION

The present invention relates to aerial systems in general and to an indoor autonomous aerial system that in particular uses micro aerial vehicle/s (MAV). Said system can be used for various purposes such as, for example, advertisement, inventory management, guidance, warning, search and rescue, etc.

### BACKGROUND OF THE INVENTION

A Micro Air Vehicle (MAV) is a miniature Unmanned Aerial Vehicle (UAV) that has various applications and uses. Many kinds of MAVs are being marketed and sold for leisure proposes and can provide, for example, an ability to capture photos or videos from an upper view or an ability to document extreme sports activities. Some MAVs are marketed as high-tech toys and include a camera capable of capturing images, and control means that enable maneuvering the MAV and navigate it to a desired location. Some MAVs can autonomously navigate to a desired location using embedded control modules in accordance with commands from an outside controller. Some MAVs are intended to be flown outdoor and some are intended for an indoor flight. While flying an autonomous MAV outdoor, a GPS sensor may be used to determine a MAV's current location and in turn, this data will be used in order to navigate the MAV to a desired location. Other control means such as, for example, an internal measurement unit (IMU) that uses a combination of gyros and accelerometers may also be used in order to maneuver and navigate a MAV to a desired location.

As opposed to expensive and sophisticated UAV, a relatively simple MAV is restricted in its ability to carry heavy sensors due to its compact measurements and humble self-weight. In certain countries, safety regulations require that an indoor MAV's weight to be less than 200 grams. Having such a low weight, an indoor MAV is incapable of carrying a variety of sensors such as, for example, complex navigation and maneuvering sensors.

Despite increasingly popular applications of MAVs in diverse sectors, their indoor operation is plagued with several challenges:
Lack of GPS information: unlike outdoor use, an indoor MAV cannot use a GPS sensor, due to lack of sufficient reception inside or beneath roofed structures.
Limited battery lifetime: typical MAVs are powered by on-board batteries which are limited in size and weight due to MAV's miniature dimensions. Hence, the flight duration of MAVs is critically constrained by limited battery lifetime. As a result, Many MAVs are only suitable for short-time flights and as a result, are considerably limited in their range, payload capacity and capabilities. For example, a MAV that weights <200 grams has a flight duration of approximately 5 to 10 minutes.
limited ability to carry sensors simple and low-price range MAVs are limited in their ability to carry payloads and hence cannot carry heavy sensors such as, for example, Ultrasonic camera, 3D camera, IMU (Inertial Measurement Units), gyro, accelerometer etc.
Control difficulties while carrying additional loads: MAVs that carry some additional weight, may exhibit control difficulties that may affect balancing and maneuvering. These difficulties may occur due to design limitations with regards to dynamics and control.
Charging station restrictions: existing charging stations that are compatible with typical MAVs require that while performing an autonomous charging, all landing gears will be in contact with defined sections of the charging surface or alternatively, are configured to enable charging by manually land a MAV on a designated surface.

Some publications disclose indoor MAVs that are capable of maneuvering without the use of a GPS sensor, for example “Deep Neural Network for Real-Time Autonomous Indoor Navigation” by Dong Ki Kim and Tsuhan Chen from Cornell University (26 Nov. 2015) discloses autonomous indoor navigation performed by a quadcopter using a single camera. A deep learning model is used to learn a controlling strategy that mimics an expert pilot's choice of action, the quadcopter has been experimented in finding various objects within indoor locations that are either narrow corridors or corners of said corridors.

Said publication discloses navigation capabilities in narrow spaces and does not address the complexities of navigating and maneuvering in expansive spaces while autonomously performing tasks. Furthermore, said publication does not disclose a MAV hovering in a single location so it can be visible and present a sign to persons in its line of sight. Said publication also does not disclose a self-charging station enabling around-the-clock constant operation. Finely, said publication does not disclose a method for inventory management using an autonomous aerial system.

The present invention relates to a cost-effective indoor autonomous aerial system that can be used for various purposes such as, for example, advertisement, inventory management, guidance, warning, search and rescue, etc. while overcoming the aforementioned drawbacks.

### SUMMARY OF THE INVENTION

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to one aspect, there is provided an autonomous aerial system, comprising at least one micro aerial vehicle (MAV); at least one image capturing means associated with the at least one MAV and a controller configured to control the at least one MAV.

According to some embodiments, the system is deployable in a reduced GPS signal reception expansive space.

According to some embodiments, the at least one MAV is configured to navigate relying on input perceived by the at least one image capturing means and in accordance with commands received by the controller.

According to some embodiments, the at least one image capturing means is an RGB camera.

According to some embodiments, the at least one image capturing means is an Infra-Red (IR) camera.

According to some embodiments, the reduced GPS signal reception expansive space is an indoor roofed structure.

According to some embodiments, no GPS signal perceived within the deployable expansive space.

According to some embodiments, the MAV is an off-the-shelf drone.

According to some embodiments, the MAV further comprises control means configured to autonomously control the MAV in accordance with commands received by the controller.

According to some embodiments, the control means provide indirect data regarding the battery level of the MAV.

According to some embodiments, the control means is an Arduino based PID controller.

According to some embodiments, the control means is an on-board single-board computer (SBC).

According to another aspect, there is provided a method for inventory management comprising the steps of autonomously navigating at least one MAV to a desired location within a deployable expansive space, relying on input perceived by at least one image capturing means; using the at least one MAV to capture data related to inventory management and conveying said data to a controller.

According to another aspect, there is provided a method for sign presentation, comprising the steps of autonomously navigating at least one MAV to a desired location within an expansive space, relying on input perceived by at least one image capturing means and presenting at least one sign using the airborne MAV.

According to some embodiments, the sign is an advertisement.

According to another aspect, there is provided a method for sign presentation, comprising the steps of autonomously navigating at least one MAV to a desired location within an expansive space, relying on input perceived by at least one image capturing means; capturing at least one image of at least one person located in line of sight with the airborne MAV; analyzing the at least one image in order to extract valuable data regarding a preferable sign presentation and presenting a preferable sign to the at least one person whose at least one image has been analyzed.

According to some embodiments, the analysis is performed using machine learning.

According to some embodiments, the valuable data is the gender of the at least one person.

According to some embodiments, the valuable data is the age of the at least one person.

According to some embodiments, the valuable data is a face recognition of the at least one person.

According to some embodiments, the valuable data is the movements statistics of the at least one person.

According to some embodiments, the preferable sign is a personalized advertisement.

According to another aspect, there is provided A method for guidance comprising the steps of autonomously navigating at least one MAV to be in line of sight with a person within a deployable expansive space, relying on input perceived by at least one image capturing means and autonomously navigating the at least one MAV to a desired location while aspiring to be in line of sight with the person.

According to some embodiments, the autonomous navigation process extrapolates fragmented data caused by non-line of sight intervals.

According to some embodiments, the aforementioned method further comprises the step of performing the aforementioned steps using an on-board single-board computer (SBC).

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 constitutes a schematic perspective view of an autonomous aerial system, according to some embodiments.

FIG. 2 constitutes a schematic perspective view of an autonomous aerial system, according to some embodiments.

FIG. 3 constitutes a schematic perspective view of an autonomous aerial system, according to some embodiments.

FIG. 4 constitutes a schematic perspective view of a self-charging station of an autonomous aerial system, according to some embodiments.

FIG. 5 constitutes a flowchart diagram illustrating a method of using an autonomous aerial system, according to some embodiments.

FIG. 6 constitutes an upper view of control means of a micro aerial vehicle (MAV) of an autonomous aerial system, according to some embodiments.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform that may be provisioned with a memory device, a Central Processing Unit (CPU) or microprocessor device, and several input/output (I/O) ports, such as, for example, a general-purpose computer such as a personal, laptop or a tablet computer, single-board computer (SBC) or a cloud computing system. Such controller may include, operate, use, employ, implement or otherwise engage artificial intelligence capabilities, such as a deep-learning system that can be, for example, conventional neural network (or CNN) configured to optimize the tasks to be controlled.

The term “PID Controller”, as used herein, refers to a proportional-integral-derivative controller that is a linear controller having a control loop feedback mechanism widely used in industrial control systems and a variety of other applications requiring continuous modulated control. PID controllers can be used to regulate a quadcopter's four basic movements: roll, pitch, yaw angles, and altitude.

The term “System Management Controller (or SMC)”, as used herein, refers to a nonlinear control technique having sliding mode control and featuring high properties of accuracy, robustness, easy tuning and implementation.

The term “Expansive Space”, as used herein, refers to any extended, vast indoor enclosure having a high volume of air. Wherein its geometrical characteristics enable a MAV to autonomously navigate without the need to constantly adjust to a narrow passageway or facing obstacles. As a result, a MAV can autonomously navigate in an expansive space by performing simpler maneuvers and require less resources comparing to a MAV navigating in a non-expansive space.

The term “Sign”, as used herein, refers to any indicia that can be visible to a person in its line of sight. Said indicia can be in the form of text, still image/s, moving images (video) or combination of the above, and may be printed or presented by a display. For example, a sign can be a warning, advertisement, promotion or any kind of marketing or messaging theme.

The term “Kalman Filter”, as used herein, refers to an algorithm that uses a series of measurements observed over time, containing statistical noise and other inaccuracies, and produces estimates of unknown variables that tend to be more accurate than those based on a single measurement alone, by estimating a joint probability distribution over the variables for each timeframe.

Reference is made to FIG. 1, which constitutes a schematic perspective view of an autonomous aerial system 10, according to some embodiments of the invention. As shown, the autonomous aerial system 10 can be deployed in expansive space A which is a reduced GPS signal reception space that can be, for example, a shopping center, a supermarket, a warehouse etc. A MAV 100 that can be, for example, an off-the-shelf commercial quadcopter, is configured to hover within expansive space A and navigate using an input received by image capturing means 102. According to some embodiments, said image capturing means 102 can be, for example, an RGB camera, an infra-red (IR) camera or any other kind of image capturing device. A controller 104, such as, for example, a PC, laptop, tablet, smartphone, Raspberry PI or any other remote control means may be used to control MAV 100 and navigate it to a desired location using a wireless communication protocol such as a two-way radio, WIFI, Blue-tooth, NFC, IR, RF (for example, by using a system on chip (SoC) such as a SoC made by Nordic Semiconductor®) or any other type of wireless communication protocol. According to some embodiments, controller 104 can use a simultaneous localization and mapping (SLAM) algorithms technology in order to enable autonomous control of MAV 100.

According to some embodiments, MAV 100 comprises control means 106 that can be, for example, an off-the-shelf PID controller. According to some embodiments, PID control means 106 comprises a real-time adaptation ability enabling a controlled flight in variable conditions that may results from the variable weight of payload installed on the MAV 100 or from drag force created by said payload. For example, a MAV 100 can be maneuverable using the PID control means 106 while carrying a sign (shown on the following figures) having mass and drag parameters that were not considered when the original MAV 100 was designed, and hence, not taken into account with regard to controlling the airborne MAV 100. According to some embodiments, a replacement of said sign with another sign having different measures, mass and drag coefficient leads to a real-time adjustment performed by the PID control means 106 and in turn to real-time ability to control the MAV 100 while carrying various signs. According to some embodiments, the PID control means 106 can be remotely adjusted by controller 104.

According to some embodiments, PID control means 106 comprises a real-time adaptation ability to variable battery levels of the MAV 100. For example, PID control means 106 can conform motor power or navigation routes to conserve energy in accordance with the MAV 100 battery level and hence, provide a prolonged flight duration.

According to some embodiments, PID control means 106 may be used in order to manage the MAV 100 energy resources. For example, while the control loop feedback mechanism of PID control means 106 measures the error rate of MAV 100 when navigating to its destination, it is also providing an indirect data regarding the battery level of MAV 100. According to some embodiments, when the error rate of the control loop feedback mechanism of PID control means 106 of MAV 100 increases, it can indicate that its battery level is low and as a result, supplies less energy to the MAV's 100 rotors. According to some embodiments, a recharge command may than be applied and cause the MAV 100 to fly back to its recharge station.

According to some embodiments, using the control loop feedback mechanism of PID control means 106 to measure the error rate of MAV 100 can validate the battery power by comparing the sum of integral error with delta time while performing tow iterations.

According to some embodiments, control means 106 can be a non-linear control means, for example, a system management controller or SMC, that may be used instead or in collaboration with the PID control means 106. According to some embodiments, a SMC may comprise a sliding mode control that has the advantage of providing a MAV 100 a dynamic behavior that may be tailored by a particular choice of the sliding mode. For example, a non-linear controller such as a SMC may neutralize error or noise resulting from a side wind that can be formed by an air-condition system or any other source.

According to some embodiments, the SMC may further comprise a closed loop response that has the advantage of being insensitive to some particular uncertainties such as, for example, model parameter uncertainties, disturbance and non-linearity.

According to some embodiments, controller 104 calculates MAV 100 battery level as a consideration for tasks operation and performance. For example, controller 104 can conform routes and operations to conserve energy in accordance with the MAV 100 battery level and hence, provide a prolonged flight duration.

According to some embodiments, autonomous aerial system 10 can provide an inventory management ability. For example, autonomous aerial system 10 can be deployed in reduced GPS signal reception spaces such as, for example, a shopping center, a supermarket, warehouse etc. According to some embodiments, the reduced GPS reception space is an expansive space A. MAV 100 that can be, for example, an off-the-shelf commercial quadcopter configured to use indoor navigation using input received by its image capturing means 102 in order to find a desired storage location within expansive space A. According to some embodiments, said image capturing means 102 can be, for example, an RGB camera, an IR camera or any other kind of image capturing device. A controller 104, such as, for example, a PC, laptop, tablet, smartphone etc. is used to control MAV 100 and navigate it to the desired storage location using a wireless communication protocol such as a two-way radio, WIFI, Blue-tooth, NFC, IR etc.

According to some embodiments, MAV 100 is configured to provide a real-time update of inventory such as, for example, recognition of missing or misaligned articles and a quantity of certain articles in the desired storage location. According to some embodiments, MAV 100 can identify the articles of interest using its image capturing means 102 or various other sensors such as, for example, a barcode reader, NFC sensor, RFID sensor, or any other type of image signal acquiring means. According to some embodiments, said real-time inventory data perceived by MAV 100 can be relayed to controller 104 for further analysis or can be directly relayed to a person in charge.

According to some embodiments, autonomous aerial system 10 can be used for security and rescue proposes by using the image capturing means 102 of the MAV 100 to detect, for example, theft or other malicious activities, missing persons or products, fire or persons in distress within the expansive space A.

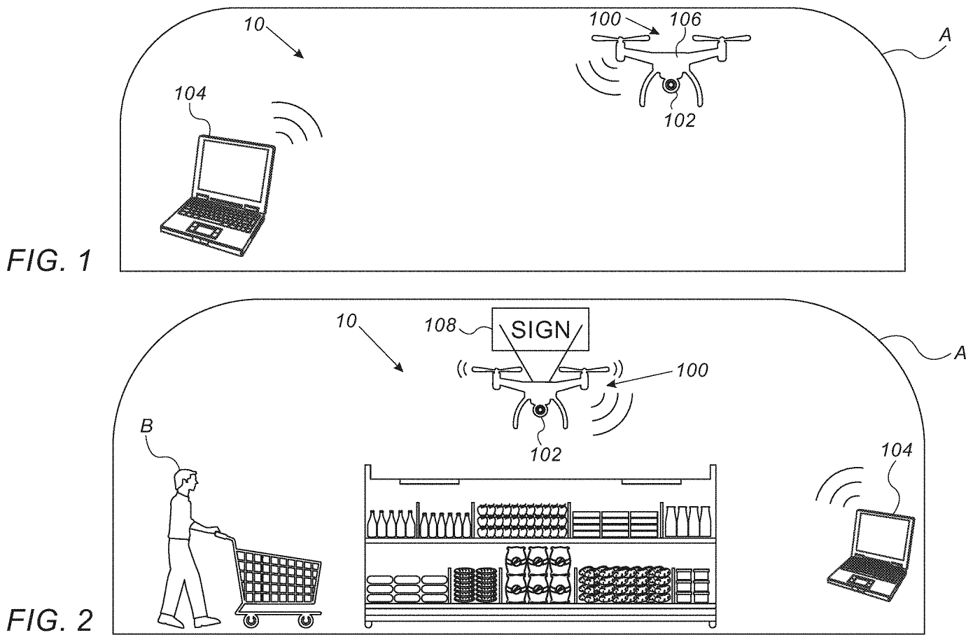

Reference is made to FIG. 2, which constitutes a schematic perspective view of an autonomous aerial system 10 according to some embodiments of the invention. As shown, MAV 100 is configured to hover and present a sign 108 that can be visible to person/s B being in line of sight with the MAV 100. According to some embodiments, MAV 100 is a quadcopter hovering in expansive space A that can be, for example, a supermarket or a shopping center. According to some embodiments, MAV 100 autonomously navigates toward a desired location, relying on input perceived by the at least one image capturing means 102 that can be, for example, an RGB camera, an IR camera or any other kind of image capturing device.

According to some embodiments, the desired location of MAV 100 can be, for example, a spot above or nearby a refrigerated showcase containing multiple products. According to some embodiments, sign 108 can be an advertisement referring to a certain product located within the showcase or in close proximity to the hovering MAV 100. A person B that approaches the desired location can see the hovering MAV 100 and be exposed to sign 108.

According to some embodiments, sign 108 is configured to be easily replaced with another sign 108 on the spot and according to various needs. According to some embodiments, sign 108 is held in place between lightweight fasteners protruding from MAV 100. According to some embodiments, sign 108 is printed on a light-weight sheet that can be, for example, a rice paper or any other kind of light-weight signage material. According to some embodiments, sign 108 can be composed of several light weight sheets capable of being replaced in accordance with various needs. According to some embodiments, sign 108 can be a digital display capable of presenting any sign 108 in accordance with various needs.

According to some embodiments, when person B approaching the hovering MAV 100, the image capturing means 102 captures image/s of person B and relays the captured image/s to controller 104 which in turn analyzes the captured image/s. According to some embodiments, said analysis can be performed using a classification center or classification database wherein said analysis of captured image/s can identify a certain characteristics of person/s B. These characteristics can be, for example, gender, age or any other relevant character. According to some embodiments, the classification process can be made using an artificial intelligent (AI) technology such as a deep-learning system that can be, for example, conventional neural network (or CNN) configured to analyze the images captured using image capturing means 102.

According to some embodiments, a core-set optimization that is dedicated to reduce training time of the CNN may be implemented, for example, the system can detect a human face, crop it from a general image captured by the image capturing means 102 and relay the extracted face to a classification center to be analyzed.

According to some embodiments, the image analysis process can be performed using a cloud computing service being in communication with controller 104. According to some embodiments, the analysis results can determine the behavior of MAV 100. For example, upon recognition of a person B's age or gender, the MAV 100 can change its behavior in a way that will contribute to an increased exposure of sign 108 seen by said person B. According to some embodiments, said increased exposure can be performed by presenting a customized sign 108 to person B in accordance with its classification, for example, a female person B in a certain age standing in line of sight with MAV 100, can be presented with a customized sign 108 that is considered to be relevant to said person B's needs or fields of interest. According to some embodiments, captured image/s of a particular person B may be captured by image capturing means 102 mounted on one MAV 100, while sign 108 presented to said person B may be mounted on another MAV 100. In other words, upon analysis resulted from image/s captured by image capturing means 102 of any MAV 100, increased exposure can be achieved by the autonomous aerial system 10 instructing any MAV 100 currently carrying a sign 108 that is considered to be relevant to said person B's to hover to a location near said person B and increase exposure of the relevant sign 108.

According to some embodiments, said increased exposure can be done by maneuvering a certain MAV 100 to a location that is visible to a certain person B that, according to its analyzed image/s, may be interested in seeing certain sign 108 presented by a MAV 100. For example, a male person B in a certain age may be approached by a MAV 100 that will hover to be in said person B's line of sight while presenting a sign 108 that is considered to be relevant to said person B's needs or fields of interests.

According to some embodiments, sign 108 can be any kind of advertisement or promotion theme. According to some embodiments, the captured image\s or video can be analyzed to extract any useful data that can be, for example, movement statistics representing the shopping habits of a certain person B or any other parameter that may contribute to an increased exposure of sign 108.

According to some embodiments, MAV 100 may rely on image capturing means 102 to navigate in spacious space 10, while considering objects that are located within its line of sight (LOS). For example, MAV 100 can lead or follow a walking person B while keeping a constant LOS with him. According to some embodiments, Leading or following a person B can be used, for example, for guidance or custom advertisement purposes.

According to some embodiments, MAV 100 may rely on image capturing means 102 to navigate in expansive space 10, while considering objects that are located outside of its line of sight (Non line of sight—NLOS), for example, MAV 100 can lead or follow person B while an obstacle of any sort, for example a supporting pillar or a partition can block its line of sight with person B for a certain period of time. According to some embodiments, control means 104 controlling MAV 100 can classify the momentary NLOS as noise of error and as such, not a factor affecting a predictable route of MAV 100.

According to some embodiments, while MAV 100 losses its line of sight with person B, control means 104 can calculate the error or noise rate and create extrapolated data indicating the current and desired location of MAV 100 and hence enable MAV 100 to continue its operation while dismissing the NLOS interval.

According to some embodiments, a filter such as, for example, a Kalman filter, may be used in order to control the MAV 100 during a NLOS interval by extrapolating statistical data and produce an estimated probable flight path.

According to some embodiments, MAV 100 may lead or follow person B to or from a desired location or route. According to some embodiments, said desired location can be a certain product that person B may find interest in or any other object or location according to various needs. According to some embodiments, MAV 100 may guide person B during a tour or a visit, for example, MAV 100 may guide person B in a museum, hotel, airport, shopping center, etc. According to some embodiments, during said guidance, MAV 100 may present a sign 108 to person B being guided or followed.

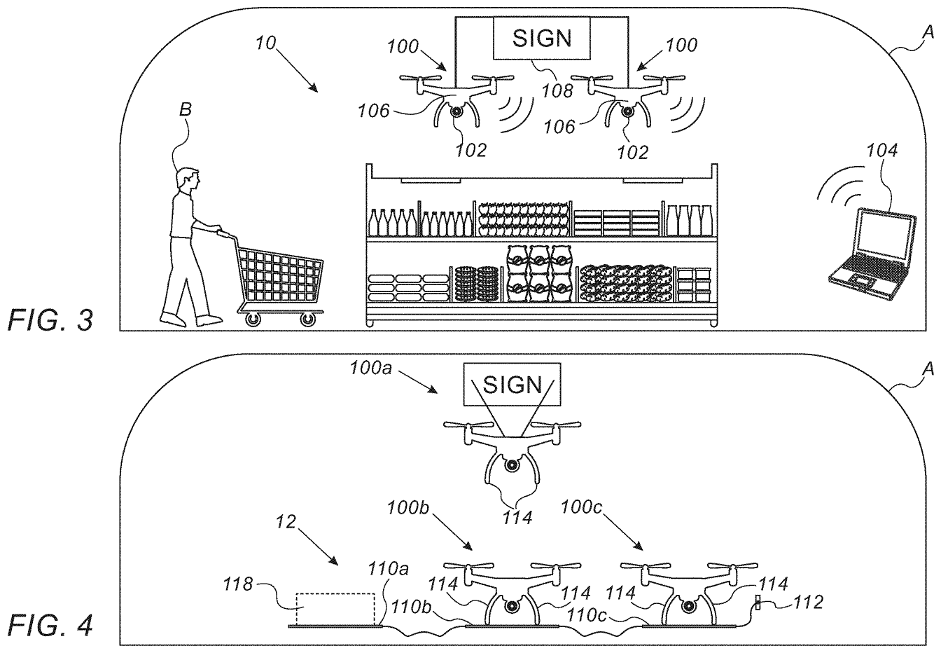

Reference is made to FIG. 3, which constitutes a schematic perspective view of an autonomous aerial system 10 according to some embodiments of the invention. As shown, at least two MAVs 100 are configured to cooperate with each other while hovering and presenting a sign 108 that is visible to person/s B being in line of sight with the MAVs 100. According to some embodiments, MAVs 100 are quadcopters hovering in expansive space A that can be, for example, a supermarket or a shopping center. According to some embodiments, MAVs 100 autonomously navigate and maneuver toward a desired location, each relying on input perceived by its image capturing means 102 that can be, for example, an RGB camera, an IR camera or any other kind of image capturing device. According to some embodiments, the outcome of multiple MAVs 100 cooperating may result in an enhanced ability to carry loads, that can be, for example a sign 108 that is too large in its mass or dimensions to be carried by a single MAV 100, or sign 108 that is a digital display.

According to some embodiments, PID control means 106, that are mounted on each of a plurality of MAVs 100 can cooperate in order to achieve a coordinated control of a formation of hovering MAVs 100. According to some embodiments, PID control means 106 can be an Arduino Uno PID controller. According to some embodiments, the MAV 100 can further comprise an Optitrack motion capture device (not shown).

Reference is made to FIG. 4, which constitutes a schematic perspective view of a self-charging station 12 of the autonomous aerial system 10, according to some embodiments of the invention. As shown, a self-charging station 12 comprises plates 110a, 110b and 110c. According to some embodiments, plates 110a, 110b and 110c comprise a conductive surface such as, for example, a metal sheet that can be made of copper, gold or any other conductive metal and configured to enable current conduction through conductive contact points (not shown) located at the distal edge of landing gears 114 of MAVs 100.

According to some embodiments, elevated rim 118 comprises a conductive surface such as, for example, a metal sheet that can be made of copper, gold or any other conductive metal and configured to enable current conduction with conductive contact points (not shown) that can be located anywhere on MAV 100. According to some embodiments, plates 110a, 110b and 110c and elevated rim 118 are connected to a main power supply such as an AC power socket 112 and configured to charge the battery of MAVs 100. According to some embodiments, plates 110a, 110b and 110c may be replaced with elevated rim 118a, 118b, and 118c respectively.

According to some embodiments, at least three MAVs 100a, 100b and 100c are configured to be periodically charged by self-charging station 12. Upon operation, MAV 100a may take-off and hover above a desired location, until its power level reaches a certain threshold indicating a depleted battery, as a result, MAV 100a can autonomously navigate back to self-charging station 12 and land while creating contact between its conductive contact points and conductive surfaces of self-charging station 12 as specified above. According to some embodiments, another MAV 100, for example MAV 100b can simultaneously or soon after take-off from its plate and replace MAV 100a on its mission. According to some embodiments, a plurality of MAVs 100 (such as, for example, MAV 100c, MAV 100d and so on) can routinely operate in the manner described above while providing an autonomous and constant aerial presence of MAVs 100 within expansive space A.

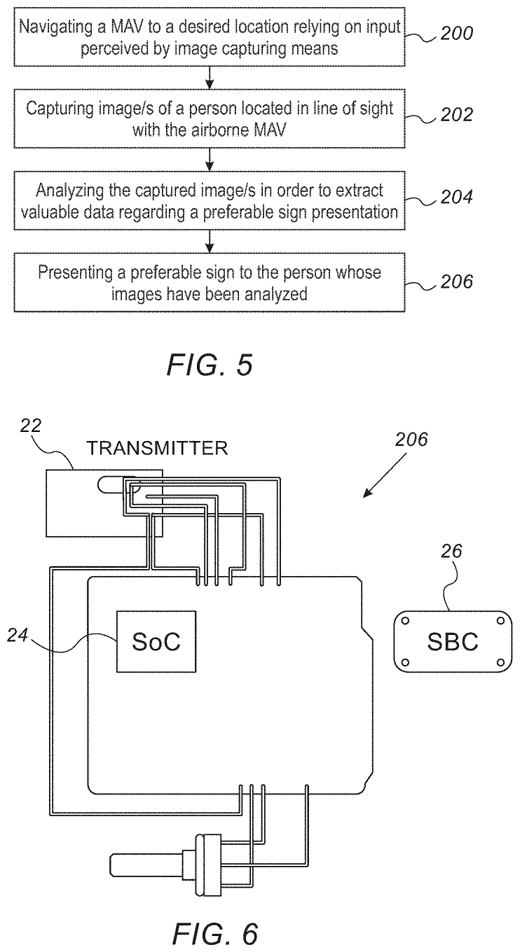

Reference is made to FIG. 5, which constitutes a flowchart diagram illustrating a method for sign 108 presentation using the autonomous aerial system 10 according to some embodiments of the invention. In operation 200, the method may include autonomously navigating at least one MAV 100 to a desired location within a deployable expansive space A while relying on input perceived by its at least one image capturing means 102 that can be, for example, an RGB camera, an IR camera or any other kind of image capturing device. According to some embodiments, MAV 100 navigates in accordance with commands received from controller 104 and/or PID or SMC control means 106. In operation 202, the method may include capturing at least one image of a person B located in line of sight with the airborne MAV 100. According to some embodiments, multiple images of multiple persons B or one image comprising multiple persons B or any other combination of images may be captured. In operation 204, the method may include analyzing the captured image/s in order to deduce valuable data regarding a preferable sign 108 presentation. According to some embodiments, said analysis is performed using a classification center or classification database by which identification of certain characteristics of person/s B in line of sight with the hovering MAV 100 can be obtained. According to some embodiments, said analysis can be performed using an artificial intelligent (AI) technology such as a deep-learning system that can be, for example, conventional neural network (or CNN) as disclosed above. According to some embodiments, the valuable data may be gender, age, face recognition, shopping habits or any other useful parameter as disclosed above. In operation 206, the method may include presenting a preferable sign 108 to at least one person B whose parameters have been analyzed. According to some embodiments, sign 108 can present a guidance, warning, an advertisement, a promotion, or any kind of marketing theme.

Reference is made to FIG. 6, which constitutes a schematic perspective view of Arduino (Uno or Nano) based PID micro-controller 206 mounted on MAV 100 according to some embodiments of the invention. As shown, MAV 100 may comprise Arduino based PID micro-controller 206 that enables an autonomous navigation and maneuverability. According to some embodiments, Arduino based PID micro-controller 206 may be integrated with MAV 100 and use PPM signals in order to communicate with controller 104 that can be, For example, a PC a tablet, a mobile cellular device, single-board computer (SBC), etc. (not shown).

According to some embodiments, Arduino based PID micro-controller 206 further comprises a transmitter 22 that can be, for example, a 2.4 Ghz radio transmitter NRF24L01 configured to transmit to MAV 100 commands received from controller 104 after being processed by the Arduino based PID micro-controller 206. According to some embodiments, an Arduino based PID micro-controller 206 may further comprising a SoC 24 such as, for example, a Nordic Semiconductor® configured to communicate with said Arduino based PID micro-controller 206 and/or controller 104. According to some embodiments, said communication can be performed using Radio Frequency (RF) protocol.

According to some embodiments, controller 104 may be a single-board computer (SBC) such as, for example, a Raspberry Pi3® used to control at least one MAV 100 in real time (not shown). According to some embodiments, the Raspberry Pi3® may communicate with at least one Arduino based PID micro-controller 206 mounted on at least one MAV 100. According to some embodiments, said Arduino based PID micro-controller 206 may further comprise a SoC 24 such as, for example, a Nordic Semiconductor® configured to communicate with said Arduino based PID micro-controller 206 and/or the Raspberry Pi3®. According to some embodiments, said communication can be performed using Radio Frequency (RF) protocol.

According to some embodiments, MAV 100 may further comprise a single-board computer (SBC) such as, for example, a Raspberry Pi Zero® 26 wherein the low weight of a Raspberry Pi Zero® 26 enable a direct configuration upon MAV 100. Raspberry Pi Zero® 26 may communicate with an Arduino based PID micro-controller 206 mounted on MAV 100. According to some embodiments, said Arduino based PID micro-controller 206 may further comprise a SoC 24 such as, for example, a Nordic Semiconductor® configured to communicate with said Arduino based PID micro-controller 206 and/or the Raspberry Pi Zero® 26.

According to some embodiments, the Raspberry Pi Zero® 26 may be connected to a Nordic Semiconductor® through a hardware connection such as, for example, a Universal Asynchronous Receiver-Transmitter (UART) (not shown).

According to some embodiments, Arduino based PID micro-controller 206 comprises a real-time autonomous recalibration ability enabling a controlled flight in variable conditions that can occur, for example, from the weight of payload installed on the MAV 100 or from drag created by said payload. For example, a MAV 100 can be maneuverable using the Arduino based PID micro-controller 206 while carrying a sign 108 having mass and drag parameters that were not part of the original MAV 100 design and hence not taken into account with regard to controlling issues of the airborne MAV 100. According to some embodiments, a replacement of said sign 108 with another sign 108 having different measures, mass and drag coefficient leads to a real-time autonomous recalibration performed by the Arduino based PID micro-controller 206 and in turn to a real-time ability to control the MAV 100 while carrying various signs 108.

Although the present invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

1-26. (canceled)

27. An autonomous aerial system, the system comprising:
(i) at least one micro aerial vehicle (MAV);
(ii) at least one image capturing means associated with the at least one MAV; and
(iii) a controller configured to control the at least one MAV;
Said system deployable in a reduced GPS signal reception expansive space,
wherein said expansive space allows autonomous navigation using simple maneuvers and low computing resources,
wherein the at least one MAV is configured to navigate to a defined location relying on input perceived by the at least one image capturing means and in accordance with commands received by the controller,
wherein the at least one MAV is configured to perform tasks while hovering at the defined location.

28. The system of claim 27, wherein the at least one image capturing means is an RGB camera.

29. The system of claim 27, wherein the at least one image capturing means is an Infra-Red (IR) camera.

30. The system of claim 27, wherein the reduced GPS signal reception expansive space is an indoor roofed structure.

31. The system of claim 27, wherein no GPS signal perceived within the deployable expansive space.

32. The system of claim 27, wherein the MAV is an off-the-shelf drone.

33. The system of claim 27, wherein the MAV further comprises control means configured to autonomously control the MAV in accordance with commands received by the controller.

34. The system of claim 33, wherein the control means provide indirect data regarding the battery level of the MAV.

35. The system of claim 33, wherein the control means is an Arduino based PID controller.

36. The system of claim 33, wherein the control means is an on-board single-board computer (SBC).

37. A method for inventory management, comprising the steps of:
(i) using an autonomous aerial system comprising at least one MAV having at least one image capturing means and a controller configured to control the at least one MAV to autonomously navigating the at least one MAV to a desired location within a reduced GPS signal reception deployable expansive space, relying on input perceived by the at least one image capturing means,
(ii) using the at least one MAV to capture data related to inventory management,
(iii) conveying said data to the controller.

38. The method of claim 37, wherein the steps are performed using an on-board single-board computer (SBC).

39. The method of claim 37, wherein the reduced GPS signal reception expansive space is an indoor roofed structure.

40. The method of claim 37, wherein the reduced GPS signal reception expansive space is an infrastructure space.

41. The method of claim 40, wherein the infrastructure space is a security structure or facility.

42. The method of claim 37, wherein the reduced GPS signal reception expansive space is an agricultural structure or facility.

43. A method for using an MAV for sign presentation comprising the steps of:
(i) using an autonomous aerial system comprising at least one MAV having at least one image capturing means and a controller configured to control the at least one MAV to autonomously navigating the at least one MAV to a desired location within a reduced GPS signal reception expansive space, relying on input perceived by at least one image capturing means,
(ii) presenting at least one sign using the airborne MAV.

44. The method of claim 43, wherein the sign is an advertisement.

45. The method of claim 43, wherein the steps are performed using an on-board single-board computer (SBC).

46. The method of claim 43, wherein the reduced GPS signal reception expansive space is an indoor roofed structure.

47. The method of claim 43, wherein the reduced GPS signal reception expansive space is an infrastructure space.

48. The method of claim 47, wherein the infrastructure space is a security structure or facility.

49. The method of claim 47, wherein the reduced GPS signal reception expansive space is an agricultural structure or facility.
